(19) United States
(12) Patent Application Publication
(10) Pub. No.: US 2005/0146877 A1
(43) Pub. Date: Jul. 7, 2005

(54) Hurricane lamp

(76) Inventor: Sanjeev Kumar, Munster, IN (US)

Correspondence Address: OLSON & HIERL, LTD.;36th Floor, 20 North Wacker Drive, Chicago, IL, 60606, US

(21) Appl. No.: 10/749,051

(22) Filed: Dec. 30, 2003

(51) Int. Cl. F21S 2/00

(52) U.S. Cl. 362/257

(57) ABSTRACT

A lamp including a base, a shade seated over the base and a coupler adapted to removably secure the shade to the base. The coupler includes head portion with a ring adapted to abut against the interior of the shade and a stem adapted to extend through an opening defined in the bottom of the shade and into the base.

### FIELD OF THE INVENTION

This invention relates to a lamp and, more particularly, to a hurricane lamp.

### BACKGROUND OF THE INVENTION

A hurricane lamp typically incorporates a glass shade which is seated on a base or stand. The shade however is most typically loosely seated on the base and is thus susceptible of being inadvertently bumped or knocked off the base.

It thus would be desirable to provide a lamp where the shade is removably secured to the base.

### SUMMARY OF THE INVENTION

The present invention is directed to a lamp comprising a base, a shade seated over the base and a coupler between the base and the shade which allows the shade to be removably secured to the base thus eliminating the risk of the shade falling off or being otherwise separated from the base.

In accordance with the present invention, the base includes a neck and the shade includes a circumferential lip which defines an opening in the bottom of the shade and is adapted to extend into the neck. The coupler in turn includes a stem which extends through the lip and into the neck. The base additionally defines a threaded bore and the coupler includes a threaded screw for threadingly securing the coupler to the base. The stem of the coupler also includes a circumferential cylindrical wall which defines a cavity adapted to receive a candle and a ring which surrounds the wall and is adapted to abut against the bottom of the shade for removably securing the shade to the base of the lamp.

Other features and advantages of the present invention will become more readily apparent from the following detailed description of the preferred embodiment of the invention, the accompanying drawings and the appended claims.

### BRIEF DESCRIPTION OF THE DRAWINGS

In the accompanying drawings forming part of the specification and in which like numerals are employed to designate like parts throughout the same,

FIG. 1 is a perspective view of a hurricane lamp in accordance with the present invention;

FIG. 2 is an enlarged, fragmentary vertical cross-sectional view of the lamp of FIG. 1;

FIG. 3 is an exploded front elevational view of the lamp of FIG. 1;

FIG. 4 is a perspective view of the coupler of the lamp of the present invention;

FIG. 5 is a top plan view of the coupler of FIG. 4; and

FIG. 6 is a bottom plan view of the coupler of FIG. 4.

### DETAILED DESCRIPTION OF THE PREFERRED EMBODIMENT

The invention disclosed herein is, of course, susceptible of embodiment in many different forms. Shown in the drawings and described herein below in detail is a preferred embodiment of the invention. It is to be understood, however, that the present disclosure is an exemplification of the principles of the invention and does not limit the invention to the illustrated embodiment.

For ease of description, the hurricane lamp of the present invention is described herein below in its usual vertical position sitting on a support surface and terms such as upper, lower, vertical, horizontal, etc., will be used herein with reference to this usual position.

Moreover, the FIGURES herein do not necessarily show details of the hurricane lamp that are known in the art and that will be recognized as such by those skilled in the art. The detailed descriptions of these elements are not necessary to an understanding of the invention. Accordingly, such elements are herein represented only to the degree necessary to aid in an understanding of the features of the present invention.

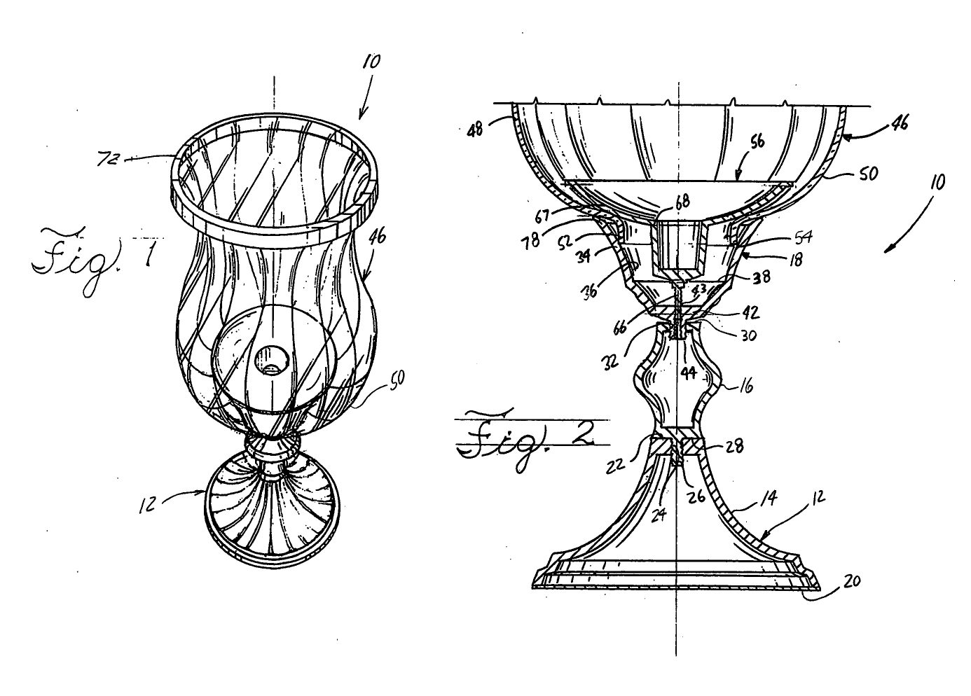

A lamp 10 in accordance with the present invention is shown in FIGS. 1-3. The lamp 10 includes a stand 12 incorporating a base 14, a hollow stem 16 and a neck or crown 18. Base 14 includes a flat bottom support face 20 and a flat top radial face 22 defining a centrally located threaded bore or opening 24. Stem 16 incorporates a fastening member in the form of a threaded screw 26 extending outwardly from a bottom radial face 28 thereof and adapted to be threaded through the opening 24 in base 14 for removably securing the stem 16 to the base 14 in a relationship wherein the face 28 of stem 16 is in abutting relationship with the top face 22 of the base 14. Stem 16 additionally incorporates a top radial face 30 defining a centrally located threaded bore or opening 32. Stem 16 can be a separate piece threadedly engaged with base 14 and crown 18 as shown or stem 16 can be unitary with base 14, as desired.

Crown or neck 18 includes a generally cup-shaped circumferentially extending wall 34 defining an open interior cavity 36. A shoulder 38 is defined on, and extends outwardly from, the interior face of the wall 34. Wall 34 additionally defines a bottom radial wall 42 defining a threaded centrally located opening or bore 43. A fastening member in the form of a unitary screw 44 or the like extends normally outwardly from the lower surface of the wall 42 and is adapted to be threaded into the bore 32 defined in stem 16 for removably securing crown 18 to the stem 16. In accordance with the invention, the bore 43 in wall 42 also extends longitudinally through the interior of screw 44.

Lamp 10 additionally comprises an elongate decorative shade 46 including a circumferential wall 48 defining a hollow interior and a bulbous or rounded base 50 which terminates in a lower peripheral circumferential neck or lip 52 defining a circular opening 54 (FIG. 2) in the bottom of the shade 46 which is in communication with the open interior thereof.

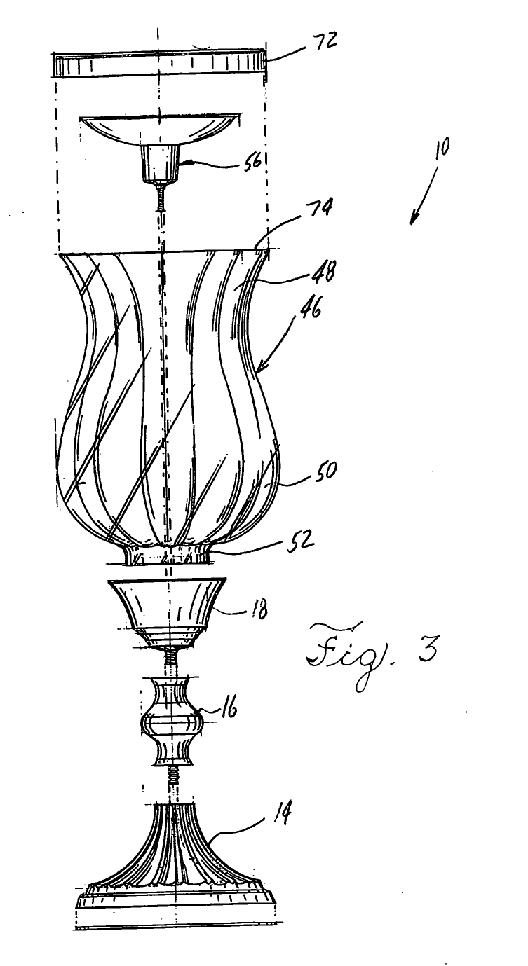

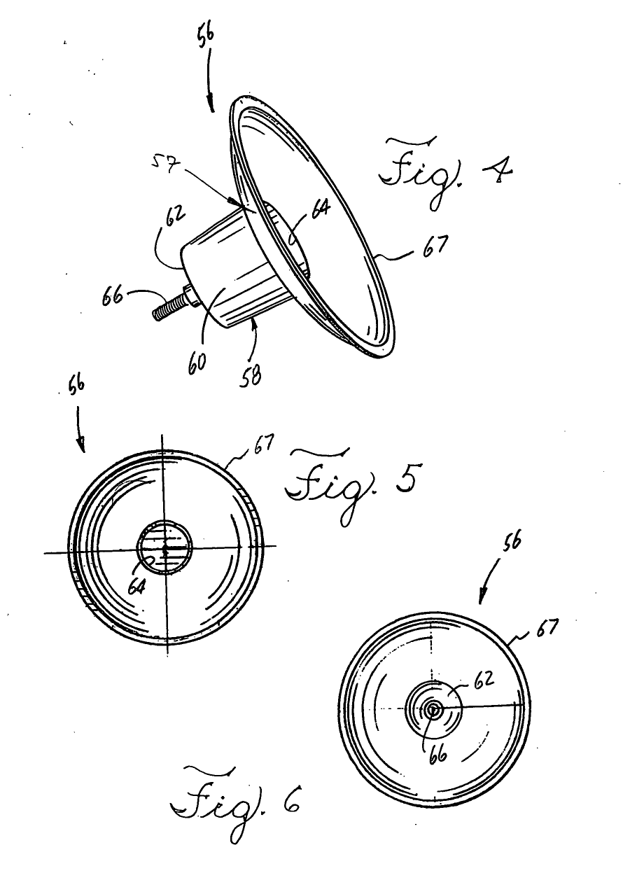

Referring to FIGS. 3-6, lamp 10 still further comprises a coupler or adapter 56 having a head portion 57, a generally cup-shaped base or stem 58 defined by a circumferential, generally cylindrically shaped outer wall 60, and a lower radial face 62. Wall 60 and face 62 together define an interior base cavity or cup 64 for receiving a candle or the like. A fastening member in the form of an elongate threaded screw 66 extends generally normally outwardly from the lower outer surface of the radial face 62 of base 58. Head portion 57 includes a dish-like circumferential curved wall or ring 67 that extends divergently upwardly and outwardly from a top circumferential peripheral edge or terminus 68 (FIG. 2) of the base 58 so as to define a bowl seated atop the base 58. Curved wall or ring 67 is unitary with base 58.

Referring back to FIGS. 1 and 3, a generally circular ring 72 is adapted to surround and be seated over the top peripheral circumferential edge 74 of the shade 46 and defines a rim therefor.

As shown in FIGS. 2 and 3, shade 46 is adapted to be seated over the crown 18 of stand 12 in a relationship wherein the lip 52 of shade 46 extends into the cavity 36 defined in the crown 18, and the portion of the wall 48 of the shade 46 defining the bulbous base 50 thereof is seated over and in contact with the top peripheral circumferential edge 78 of the crown 18.

Coupler 56 removably secures the shade 46 to the crown 18 to eliminate the risk of the shade 46 being knocked off the stand 12. Particularly, coupler 56 is adapted to be inserted through the interior of the shade 46 from the position of FIG. 3 to the position of FIG. 2 so that the lower surface of the head portion 57 of coupler 56 is positioned in abutting relationship against the inner surface of the portion of the wall 48 which defines the bulbous base 50 of the shade 46 and the stem 58 of coupler 56 extends through the opening 54 defined in the lip 52 of shade 46 into the cavity 36 defined in the crown 18 of stand 12. Screw 66 is aligned longitudinally with the threaded bore 43 defined in the lower face 42 of crown 18 and coupler 56 is rotated relative to the shade 46 and stand 12 for threadingly securing screw 66 into bore 43, thus removably securing the shade 46 to the stand 12.

Although not shown, a candle can be received into the interior of shade 46 and seated in cavity 64 of coupler 56. Ring 67 of coupler 56 can thus serve as a wax repository for the candle.

What has thus been described is a lamp incorporating a coupler which allows a shade to be removably secured to a lamp stand while also serving the further purpose of a candle stand.

1. A lamp comprising a base, a shade and a coupler between the base and the shade removably securing the shade to the base.

2. The lamp of claim 1 wherein the base includes a neck and the shade includes a lip adapted to sit in the neck, the coupler including a stem extending through the lip and into the neck.

3. The lamp of claim 2 wherein the base defines a threaded bore and the coupler includes a threaded screw for threadingly securing the coupler to the base.

4. The lamp of claim 2 wherein the stem of the coupler includes a circumferential cylindrical wall defining a cavity adapted to receive a candle.

5. The lamp of claim 4 wherein a ring surrounds the wall defining the stem.

6. A coupler adapted to removably secure a hollow lamp shade to a lamp base, the coupler including a head portion for seating within the lamp shade and a stem adapted to extend between the shade and the base.

7. The coupler of claim 6 wherein the head portion includes a ring unitary with the stem and adapted to abut against the interior of the shade.

8. The coupler of claim 6 wherein the stem defines a cavity adapted to receive a candle.

9. The coupler of claim 6 wherein the stem includes a fastening member for threadingly securing the coupler to the lamp base.

10. A lamp comprising:
a base including a neck defining an interior cavity;
a shade seated over the neck and including a lower circumferential lip defining an opening in the shade; and
a ring seated against the interior of the lip and including a stem extending through the opening defined in the shade and into the cavity defined in the neck, the stem being releasably secured to the base for releasably securing the shade to the base.

11. The lamp of claim 10 wherein the base defines a threaded bore and the stem includes a screw threadingly releasably secured in the bore.

12. The lamp of claim 10 wherein the stem defines a cup adapted to receive a candle and the ring surrounds a top circumferential edge of the cup.
